(19) United States
(12) Patent Application Publication
(10) Pub. No.: US 2026/0053284 A1
(43) Pub. Date: Feb. 26, 2026

(54) TENSION RELEASE PILLOW CASE INSERTS SYSTEM

(71) Applicant: Jean-Francois Asselin, Bolton-Est (CA)

(72) Inventor: Jean-Francois Asselin, Bolton-Est (CA)

(21) Appl. No.: 19/106,093

(22) PCT Filed: Aug. 25, 2023
(86) PCT No.: PCT/IB2023/058420

§ 371 Date: Feb. 26, 2025

Related U.S. Application Data
(60) Provisional application No. 63/401,257, filed on Aug. 26, 2022.

(51) Int. Cl. A47G 9/10; B32B 5/02; B32B 5/12; B32B 5/26

(52) U.S. Cl. CPC A47G 9/1045; B32B 5/024; B32B 5/12; B32B 5/263; B32B 2250/02; B32B 2250/20

(57) ABSTRACT

The present invention relates to alignment of pillowcase inserts in order to prevent wrinkle formation and enhance sleep. Further, relates to arrangement of multiple layers of pillow case inserts aligned in specific angle with each other consecutively to reduce friction between the pillow, the pillow case inserts, and arrangement of multiple pillow case insert layers in calculated angle of alignment with each other, leading to reduced static friction otherwise caused due to weight and friction of the head on the facial skin during the period of time, when in contact with pillow. Method of use of the pillow case inserts for postoperative patients who have undergone facial cosmetic surgery, burns and or neck injury or surgeries thereof.

### TECHNICAL FIELD

The present invention generally relates to pillow case inserts for reducing static friction and its methods of use thereof.

### PROBLEM STATEMENT AND HISTORY INTERPRETATION CONSIDERATIONS

### Interpretation Considerations

This section describes the technical field in detail and discusses problems encountered in the technical field. Therefore, statements in the section are not to be construed as prior art.

### Discussion of History of the Problem

Facial wrinkles are typically associated with aging forced to appear unyouthfully. Many measures are being taken for reducing wrinkles and aging. “A huge factor in aging during sleep is the shearing force created by movement of skin against the pillow.” Multiple times of contact pressing of pillow over a life time creates a significant increase in wrinkle formation on decolletage and cheek.

Side sleeping can lead to wrinkles on décolletage and cheek on the side in contact with traditional pillow. Numerous different approaches have been proposed in the past to reduce or eliminate wrinkles. This approach typically focuses on the face and neck and may take the form of a pillow, which supports the face and neck during sleep. The approaches may be classified into physical, medical, or chemical in nature. One prior art approach is in the form of a contour type pillow which is designed to keep the skin off the surface of the pillow. This approach suffers from the inherent difficultly in attempting to keep a user's skin off the pillow and the discomfort that causes the user, which may interrupt normal sleep patterns.

Another negative effect of the shear forces between the skin and the pillow is when user is repositioning head on the pillow. This action can induce muscle tension and contribute nonalignment of spine compared to optimal natural position. The more common proposed solution to reduce the shear forces are silk or shiny faced satin pillowcase to prevent skin chafing and minimize negative effects.

Other solution proposed to reduce the wrinkle and shear forces are use of soft fabrics like shiny faced satin or silk as a pillowcase, leading to direct contact with the skin of the user. The leads to a problem of induced abrasive action between skin or air caused due to friction on the surface of the pillow case. As an average person moves about 13 to 15 times an hour during sleep and accumulation of little abrasive force on the skin each time may contribute to skin damage.

### Related Publications in the Prior Art

The prior art applications US20120227185 titled as Anti-wrinkle fabric arrangement and CN 204048994 titled as a kind of pillow with traction and antiwrinkle function, do not comprise the advanced features of the present invention.

### SUMMARY

The present invention relates to alignment of pillowcase inserts in order to prevent wrinkle formation and enhance sleep.

In one of the embodiments of present invention relates to arrangement of multiple layers of pillow case inserts aligned in specific angle with each other consecutively to reduce friction between the pillow and pillow case inserts.

In one of the embodiments, the present invention relates to arrangement of multiple pillow case insert layers in calculated angle of alignment with each other, leading to reduced static friction otherwise caused due to weight of the head on the facial skin during the period of time, when in contact with pillow case. And the slipping characteristic feature is due to arrangement of placing the two shinny sides, of the pillow case inserts face to face with crossed warp yarn.

In one of the embodiments, of present invention relates to arrangement of pillow case inserts of fabric aligned in the angle of not less than 25 degrees to the range of not more than 95 degrees in coordination with subsequent or similar layered pillow cover inserts.

Further, the present invention relates to reduction in shear traction between the skin and the pillow, thus comforting the head rotation to a natural alignment posture, contributing to a better comfort during sleep.

Additionally, the method of use of pillow case insert aligned specifically to shear forces created due to beard acting like a cramp ons over the pillow case in contact with the skin, by releasing force under the pillow case, thus beard to pressurize skin of the user during repositioning.

In the preferred embodiment of the present invention, relates to process of comparative analysis of static friction on the skin of user an experimented replica fabric as human skin, while using pillow with traditional pillow cover compared to pillow with aligned pillow insert covers comprises of: —
1. Step (a), test is used to determine the static (starting) resistance of one surface being dragged across another.
2. Step (b), a specimen of weight 3293 grams is attached to a sled.
3. Step (c), sled is pulled across a second surface at a speed of 150 mm/minute.
4. Step (d), comprises of 100% two cotton pillow case layer and two layers of polyester shiny faced satin, crossed yarn with a specimen size of individual 635 mm (2.5 in) square specimens along a path of 79.75 sq/inch surface.
5. Step (e), is where static coefficient of friction can be calculated.
6. Step (f), the static coefficient of friction is equal to the initial force scale reading divided by the sled weight and force to get the sled started (static) and to maintain motion (kinetic) is measured.

TABLE 1

| | | Initial force scale | | Sled |
|---|---|---|---|---|
| | | reading to get | Sled | weight in |
| Sno. | Type of fabric | the scale moving | surface | grams |
| 1. | 100% two Cotton | 2525 g of traction | 79.75 | 3293 g |
| | Pillow case layer | | sq/inch | |
| 2. | Two layers of | 570 g of traction | 79.75 | 3293 g |
| | polyester shiny | | sq/inch | |
| | faced satin, | | | |
| | crossed warn | | | |

The present invention relates multilayered pillow case inserts manufactured from but not limited to are polyester shiny faced satin, silk, rayon, nylon. And the weight of each layer of fabric is in the range of 50 to 250 grammes per yard.

In one of the embodiments the process of the placing present invention over the pillow, under the pillow case in contact with the skin, is described in detailed steps as follows:
1. Step 1, is initiated by placing a clean or washed pillow insert A with specific parallel orientation of yarn, over the pillow.
2. Step 2, is the continued by placing the second pillow insert B with specific vertical orientation of yarn, over the step 1 set up.
3. Step 3, can be further continued with additional inserts consecutively.
4. Step 4, is the placing of a normal pillow case over step 2 or step 3.
5. The pillow is ready for the resting with layers of pillow inserts, to rest over.

### BRIEF DESCRIPTION OF THE DRAWINGS

Various aspects of the invention and its embodiment are better understood by referring to the following detailed description. To understand the invention, the detailed description should be read in conjunction with the drawings, in which:

FIG. 1, illustrates an exemplary position of the head on the pillow during rest.

FIG. 2, illustrates an exemplary position of the head in the supine position on pillow during rest by using pillow case inserts of the present invention.

FIG. 3, illustrates a detailed filling of yarn.

FIG. 4, illustrates respective orientation of fabric A and fabric B, along with alignment.

FIG. 5, illustrates increased friction points between two pillow case inserts with parallel alignment of the warp yarn, increasing friction due to unidirectional sliding effect.

FIG. 6, illustrates reduced friction points between two pillow case inserts with crossed warp yarn

### DESCRIPTION OF AN EXEMPLARY PREFERRED EMBODIMENT

The preferred embodiments of the present disclosure are disclosed herein, however, it is to be understood that the disclosed embodiments are merely exemplary of the invention, which may be embodied in various forms. Therefore, specific structural and functional details disclosed herein are not to be interpreted as limiting, but merely as a representative basis for teaching one of the ordinary skilled in the art to variously employ the present invention. The embodiments disclosed herein are not to be interpreted as a limitation.

Definitions: Below are the definitions of the terms used for the present invention are: —

i. Pillow is defined as a rectangular cloth bag stuffed with feathers or other soft materials, used to support the head when lying or sleeping.

ii. Pillow case is defined as a removable cloth cover for a pillow.

iii. Shiny faced satin is defined as a smooth, glossy fabric, usually of silk, produced by a weave in which the threads of the warp are caught and looped by the weft only at certain intervals.

iv. Warp and weft are the two basic components used in weaving to turn thread or yarn into fabric. The lengthwise or longitudinal warp yarns are held stationary in tension on a frame or loom while the transverse weft is drawn through and inserted over and under the warp.

v. Pick is defined as a single thread of weft crossing warp is called as pick.

vi. Warp end is defined as a set of yarns.

vii. Wrinkle is defined as a slight line or fold in something, especially fabric or the skin of the face.

In the preferred embodiment of the present invention, relates to process of comparative analysis of static friction between the pillow case and pillow and between the two layers of the pillow case inserts comprises of: —
1. Step (a), test is used to determine the static (starting) resistance of one surface being dragged across another.
2. Step (b), a specimen of weight 3293 grams is attached to a sled.
3. Step (c), sled is pulled across a second surface at a speed of 150 mm/minute.
4. Step (d), comprises of 100% two cotton pillow case layer and two layers of polyester shiny faced satin, crossed yarn with a specimen size of individual 635 mm (2.5 in) square specimens along a path of 79.75 sq/inch surface.
5. Step (e), is where both static and kinetic coefficient of friction can be calculated.
6. Step (f), the static coefficient of friction is equal to the initial force scale reading divided by the sled weight.
7. Step (d), and force to get the sled started (static) and to maintain motion (kinetic) is measured.
8. Step (h), the kinetic coefficient of friction is equal to the average force reading obtained during uniform sliding of the surfaces divided by the sled weight measured in grams.

### Interpretation Considerations

While reading this section (Description of an Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art.

Furthermore, as technology develops, numerous additional alternatives to achieve an aspect of the invention may arise. Such advances are incorporated within their respective genus and should be recognized as being functionally equivalent or structurally equivalent to the aspect shown or described.

Unless explicitly stated otherwise, conjunctive words (such as “or”, “and”, “including”, or “comprising”) should be interpreted in the inclusive and not the exclusive sense.

As will be understood by those of the ordinary skill in the art, various structures and devices are depicted in the block diagram to not obscure the invention. In the following discussion, acts with similar names are performed in similar manners, unless otherwise stated. The foregoing discussions and definitions are provided for clarification purposes and are not limiting. Words and phrases are to be accorded their ordinary, plain meaning, unless indicated otherwise.

### Description of the Drawings, a Preferred Embodiment Introduction

The present invention generally relates to pillow case inserts, and, more particularly, to multiple pillow case inserts arranged in specifically aligned angle, in order to reduce static friction. The present invention also relates to method of use of pillow case inserts for reduction in the formation of wrinkles or fine lines on the face due to pressure created on face during one side sleeping. The alignment of the multiple pillow inserts is in an angle which reduces the static friction, and leads to smooth movement of the face when leaned towards pillow. Further, it leads to protection of patients who have sensitive skin after burns, cosmetic surgery, or neck injury etc. Thus, present invention saves 100 of dollars towards buying expensive pillow covers.

The figures below illustrate an example embodiment comprising of detailed features and method of use of pillow inserts.

### DESCRIPTION OF THE FIGURES

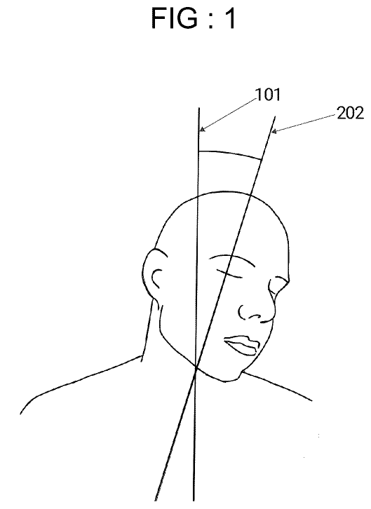

FIG. 1, illustrates a detailed and functional schematic exemplary position of the head on the pillow during rest. The details include 101, the angle of alignment, with spine and 102, is the deviation from the supine position during resting on pillow. For instance, when sleeping in supine position and rotating the head, the friction will lead to a change in the spine alignment and therefore, tension in the neck muscles applied.

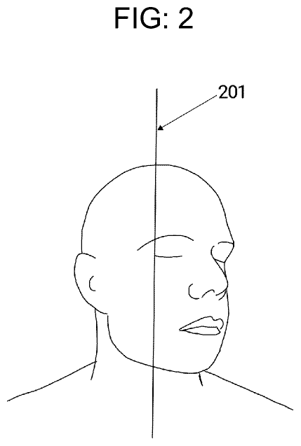

FIG. 2, illustrates an exemplary position of the head in the supine position on pillow during rest 201. The position is very healthy position for alignment of neck and spine muscles, in natural alignment by using the pillow case inserts of the present invention.

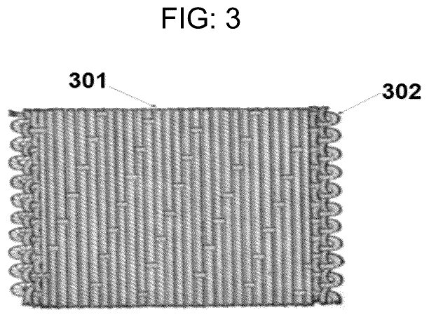

FIG. 3, illustrates a detailed filling of yarn of the pillow insert fabric of the invention. 301 being the warp yarn and 302, is the weft yarn.

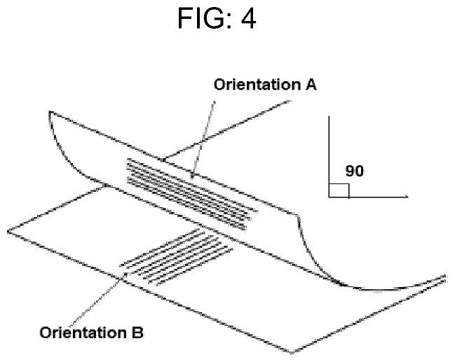

FIG. 4, illustrates an example of respective orientation of fabric A having the yarn arranged in the parallel orientation and fabric B, having the yarn arranged in the vertical orientation along with alignment

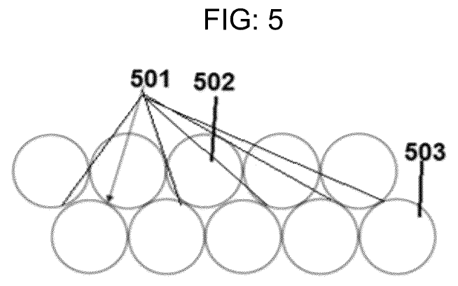

FIG. 5, illustrates increased friction points between two pillow case inserts with parallel alignment of the warp yarn, increasing friction due to unidirectional sliding effect. The detailed features displayed are 502 and 503 are the warp yarns of the shinny side surface of a satin fabric, and 501, is the aggregation of frictional points formed due the increased contact surface of the warp yarn when aligned.

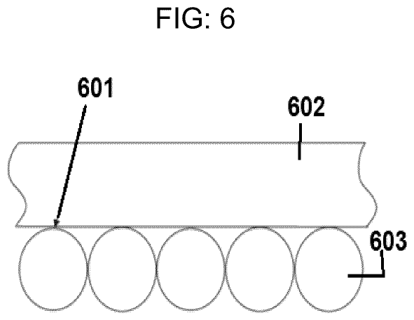

FIG. 6, illustrates reduced friction points between the pillow case inserts. The detailed features displayed are 602, that is one layer of the multilayered pillow case inserts and 603, another layer of the multilayered pillow case insert, with warp yarns crossed. 601, being the aggregation of frictional points and are reduced, comparatively to aggregation of formed frictional points 501, of FIG. 5.

It will readily be apparent that numerous modifications and alterations can be made to the processes described in the foregoing examples without departing from the principles underlying the invention, and all such modifications and alterations are intended to be embraced by this application.

1. An arrangement of pillowcase inserts comprising at least two layers of material selected from the group consisting of polyester shiny-faced satin, silk, rayon, or nylon, each layer possessing at least one shiny side, wherein the two shiny sides are oriented to face each other, and the warp yarn of the two opposing layers is oriented at an angle between 25 to 150 degrees in a crossed direction.

2. The arrangement of pillowcase inserts according to claim 1, wherein the pillowcase inserts of fabric are positioned at an angle not less than 25 degrees and not more than 95 degrees to align with subsequent or similar layered pillow cover inserts.

3. The arrangement of pillowcase inserts according to claim 1, wherein the material is satin.

4. A method of using a pillowcase insert, the method comprising aligning the pillowcase insert in a manner where the warp yarn of the two opposing layers is oriented at an angle between 25 to 150 degrees in a crossed direction, as specified in claim 1.
